(19) United States
(12) Patent Application Publication
(10) Pub. No.: US 2008/0211633 A1
(43) Pub. Date: Sep. 4, 2008

(54) METHOD AND APPARATUS FOR VERIFYING IDENTIFICATION OF RADIO FREQUENCY IDENTIFICATION TAG

(75) Inventors: Kye Hwan Oh, Yongin-si (KR); Albert Sejean Oh, San Jose, CA (US)

Correspondence Address: HAMMER & ASSOCIATES, P.C., 3125 SPRINGBANK LANE, SUITE G, CHARLOTTE, NC, 28226, US

(73) Assignees: Kye Hwan Oh; Albert Sejean Oh; Onnuri Electronics Inc. Ltd.

(21) Appl. No.: 12/039,848

(22) Filed: Feb. 29, 2008

(30) Foreign Application Priority Data
Mar. 2, 2007 (KR) 10-2007-0020987

(51) Int. Cl. H04Q 5/22

(52) U.S. Cl. 340/10.1

(57) ABSTRACT

A method and apparatus for verifying an identification of an RFID tag that can verify whether all the information is identified from a plurality of RFID tags attached to a plurality of objects is provided. The method includes: reading object data and the weight data from the plurality of RFID tag attached to the plurality of objects; measuring actual total weight of the plurality of objects; comparing the measured actual total weight with calculated total weight corresponding to a sum of the read weight data; and verifying the automatic identification result about the plurality of objects through the comparison between the measured actual total weight and the calculated total weight.

### CROSS-REFERENCE TO RELATED APPLICATION

This application claims the benefit of Korean Patent Application No. 10-2007-0020987, filed on Mar. 2, 2007, in the Korean Intellectual Property Office, the disclosure of which is incorporated herein by reference.

### BACKGROUND OF THE INVENTION

1. Field of the Invention

The present invention relates to a method and apparatus for verifying an identification of a radio frequency identification (RFID) tag, and more particularly, to a method and apparatus for verifying an identification of an RFID tag that can verify whether all the information is identified from a plurality of RFID tags attached to a plurality of objects.

2. Description of Related Art

Radio frequency identification (RFID) is a technology that can identify a target such as an object and a human being, using a radio frequency (RF). RFID is used for a scheme of recording information appropriate for the purpose of use in an RF tag consisting of an antenna and a chip, and attaching the RF tag to a target object, and then identifying the recorded information using an RFID reader. Also, an RFID system is applied to the management of inventory, sales, parking, books, and the like, a traffic card, a card for restricting access, animal identification, a highway pass card, and the like. An RFID system generally includes a tag, an antenna, a reader, and a host as basic components.

Generally, a tag attached to an object includes an integrated circuit (IC) chip for receiving data and an antenna for wirelessly transmitting and receiving information to/from an RFID reader. The tag is classified into an active type and a passive type depending on whether a battery is embedded into the tag. The tag may wirelessly transmit, or transmit and receive unique information of a product or an object. The antenna may radiate an RF, receive data from the tag, and transfer the received data to a reader. The reader may control frequency transmission and read the data received from the tag. A host processes data read from a single or a plurality of tags, and manages a plurality of distributed reader systems.

In comparison to a current, widely-used barcode system, an RFID system may record a relatively large amount of information in an RFID tag, and enable information transmission between the RFID tag and a transceiver without contacting an object attached with the RFID tag to a reader of the transceiver. However, when a plurality of RFID tags exists within the range where an RFID reader can read the RFID tag, the plurality of RFID tags simultaneously responds to a signal of the RFID reader. Therefore, a collision occurs among the plurality of RFID tags.

Here, the collision may include a reader collision where a plurality of readers simultaneously requests a single tag for a response to a query and thus the tag is confused trying to recognize the request, and may include a tag collision where a plurality of tags simultaneously responds to a query of a single reader and thus the reader cannot identify a particular tag. In the case of the tag collision, since a passive tag is used for a physical distribution of a large scale, there are some constraints such as a calculation complexity, the absence of a battery, and a cost increase according to a memory size, and the like, in applying an available collision preventing protocol.

Also, even though the collision preventing protocol is applied, an RFID identification rate may be low or impossible depending on a frequency type used in an RFID system. For example, in the case of the RFID system using a high frequency band, there is a problem that an identification rate is low in metal or liquid environments. Also, in the case of the RFID system using a microwave band, when there is a shield, identification is impossible.

Therefore, when the RFID system identifies information from a plurality of RF tags attached to a plurality of objects, it is difficult to make it sure that information of all the objects are completely identified using a reader.

### BRIEF SUMMARY

An aspect of the present invention provides a method and apparatus for verifying an identification of a radio frequency identification (RFID) tag that can verify whether all the information is identified from a plurality of RFID tags attached to a plurality of objects, regardless of whether a collision occurs and whether a shield exists.

Another aspect of the present invention also provides a method and apparatus for verifying an identification of an RFID tag that can provide a unit capable of verifying whether all the information is identified from a plurality of RFID tags and thereby can reduce a process time of a physical distribution of a large scale.

According to an aspect of the present invention, there is provided a method of verifying, using a radio frequency identification (RFID) tag, an automatic identification result about a plurality of objects, wherein each object is attached with an RFID tag including weight data of the object, the method including: reading object data and the weight data from the RFID tag; measuring actual total weight of the plurality of objects; comparing the measured actual total weight with calculated total weight corresponding to a sum of the read weight data; and verifying the automatic identification result about the plurality of objects through the comparison between the measured actual total weight and the calculated total weight.

Here, in the reading, when a plurality of objects is located within the range where an RFID tag reading unit can read an RFID tag, the data may be received from each RFID tag respectively attached to each of the plurality of objects.

Also, in the measuring, the measured actual total weight may be obtained by collectively measuring the total weight of the plurality of objects. Depending on cases, the measured actual total weight may be obtained by consecutively measuring the weights of each object of the plurality of objects for at least one object among the plurality of objects.

Also, in the comparing, the calculated total weight is a sum of the weight data of each object read from each RFID tag, and the measured actual total weight is the total weight that is obtained by collectively measuring the total weight of all of the plurality of objects, or summing up the consecutively measured weights of each object of the plurality of objects.

Also, when the calculated total weight is outside a predetermined error range as the result of the comparison between the measured actual total weight and the calculated total weight, the verifying may indicate the automatic identification result as an error process. Conversely, when the calculated total weight is within the error range as the result of the comparison between the measured actual total weight and the calculated total weight, the verifying may indicate the automatic identification result as a normal process.

Also, the reading may be performed by reading the object data and the weight data from the RFID tag attached to each of the plurality of objects while passing through a predetermined measurement region. The measuring may be performed when the plurality of objects passes through the measurement region. Here, the measurement region may be within the range where the RFID tag reading unit can read the RFID tag, and also may be a region in which a device is installed for measuring the actual total weight of the plurality of objects.

According to another aspect of the present invention, there is provided a method of verifying, using an RFID tag, an automatic identification result about a plurality of objects, wherein each object is attached with the RFID tag including physical data corresponding to a physical characteristic of the object, the method including: reading object data and the physical data from the RFID tag; measuring actual physical data of each object of the plurality of objects; comparing a measured value with a calculated value, wherein the calculated value is a sum of the read physical data and the measured value is a sum of the measured actual physical data; and verifying the automatic identification result about the plurality of objects through the comparison between the calculated value and the measured value.

Here, in the reading, when a plurality of objects is located within the range where an RFID tag reading unit can read an RFID tag, the data may be received from each RFID tag respectively attached to each of the plurality of objects.

Also, in the measuring, the actual physical data may be obtained by collectively measuring the physical characteristics of all of the plurality of objects. Depending on cases, the actual physical data may be obtained by consecutively measuring the physical characteristics of each object of the plurality of objects for at least one object among the plurality of objects.

Also, in the comparing, when the physical data is, for example, data corresponding to the weight of the object, the calculated value is a sum of weight data read from each RFID tag and the measured value is the total weight that is obtained by collectively measuring the total weight of all of the plurality of objects, or summing up the consecutively measured weights of each object of the plurality of objects.

Also, when the calculated value is outside a predetermined error range as the result of the comparison between the measured value and the calculated value, the verifying may indicate the automatic identification result as an error process. Conversely, when the calculated value is within the error range as the result of the comparison between the measurement and the calculated value, the verifying may indicate the automatic identification result as a normal process.

Also, the reading may be performed by reading the object data and the physical data from the RFID tag attached to each of the plurality of objects while passing through a predetermined measurement region. The measuring may be performed when the plurality of objects passes through the measurement region. Here, the measurement region may be within the range where the RFID tag reading unit can read the RFID tag, and also may be a region where a device is installed for measuring the actual total weight of the plurality of objects.

According to still another aspect of the present invention, there is an apparatus of verifying, using an RFID tag, an automatic identification result about a plurality of objects, wherein each object is attached with the RFID tag storing physical data corresponding to a physical characteristic of the object, the apparatus including: a reading unit to read object data and the physical data from the RFID tag; a measurement unit to measure actual physical data of the plurality of objects; and a control unit to compare a measured value with a calculated value, wherein the calculated value is a sum of the read physical data and the measured value is a sum of the measured actual physical data.

Here, the reading unit functions to read object data and recorded physical data from an RFID tag. A reader of an RFID system may correspond to the reading unit. The reader controls frequency transmission and interprets data received from the RFID tag. An antenna may include an RF circuit, a modulator/demodulator, a real-time signal processing module, a protocol, a processor, and the like.

The object data denotes basic information of each object, for example, manufacturing location, a manufacturer, manufacturing date, and the like, that is recorded as data in the RFID tag. The recorded physical data denotes the physical characteristic of the object that is recorded as data in the RFID tag. The physical characteristic denotes a characteristic that determines a physical property of a material or a thermal, optical, electrical, or magnetic property as quantity. A representative example of the physical characteristic may be a weight, a volume, and the like. Also, the RFID tag may be an RF tag attached to the object.

The measurement unit functions to measure the actual physical characteristic of the plurality of objects. The actual physical characteristic may be obtained by collectively measuring the physical characteristic of all of the plurality of objects. Depending on cases, the actual physical characteristic may be obtained by consecutively measuring the physical characteristic of each object of the plurality of objects for at least one object among the plurality of objects.

The control unit functions to compare the calculated value, which is a sum of the read physical data, with the measured value which is the measured actual physical data. When the physical data is, for example, data corresponding to the weight of the object, the calculated value is a sum of weight data read from each RFID tag and the measured value is the total weight that is obtained by collectively measuring the total weight of the plurality of objects, or summing up the consecutively measured weights of each object of the plurality of objects.

Also, the apparatus may further include an error process indication unit to indicate the automatic identification result as an error process when the calculated value is outside a predetermined error range as the result of the comparison between the measured value and the calculated value. Also, the apparatus may further include a normal process indication unit to indicate the automatic identification result as a normal process when the calculated value is within the error range as the result of the comparison between the measured value and the calculated value. The error process indication unit or the normal process indication unit may be a terminal and the like.

Since it is unlikely that the measured value and the calculated value have the same exact value, it is possible to process the measured value and the calculated value as the same value when both the measured value and the calculated value are within the predetermined error range. Therefore, when both the measured value and the calculated value are within the predetermined error range, it is regarded that the object data is identified from all the RFID tags attached to the plurality of objects and thus it is possible to indicate the automatic identification result as a normal process using the normal process indication unit.

The error range may be variously determined and be changed depending on an object type, a measurement unit of the physical characteristic, and the like. For example, in the case of the same object type, the error range may be determined as a relatively small value. Conversely, in the case of various object types, the error range may be determined as a relatively large value. Also, as the weight of the object increases, the error range may be determined as a larger value.

As described above, when the calculated value is outside the error range as the result of the comparison, it is possible to indicate the automatic identification result as an error process using the error process indication unit. In this case, the control unit controls the reading unit to re-read object data and recorded physical data from the RFID tags attached to the plurality of objects, and then compare a recalculated value, which is a sum of the re-read physical data obtained in the re-reading, with the measured value which is the sum of the measured actual physical data obtained in the measuring, and repeat the re-reading until the recalculated value is within the error range.

Here, when the re-reading process is repeated more than a predetermined number of times, that the process is not normally processed is informed to a user using the error process indication unit, so that the user may perform a subsequent procedure. The number of repeating times may be variously determined depending on an object type, an RF tag type, and the like.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an apparatus for verifying an identification of a radio frequency identification (RFID) tag according to an exemplary embodiment of the present invention;

FIG. 2 is a flowchart illustrating a method of verifying an identification of an RFID tag according to an exemplary embodiment of the present invention; and

FIG. 3 is a flowchart illustrating a method of verifying an identification of an RFID tag according to another exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

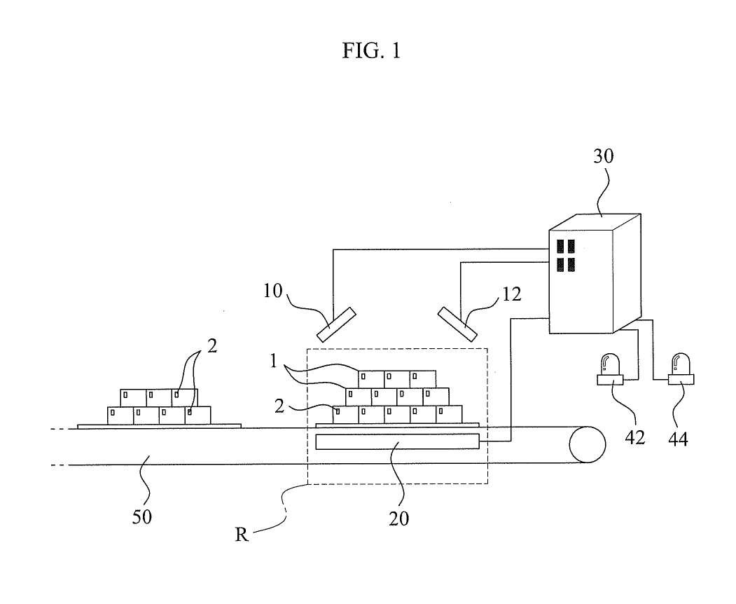

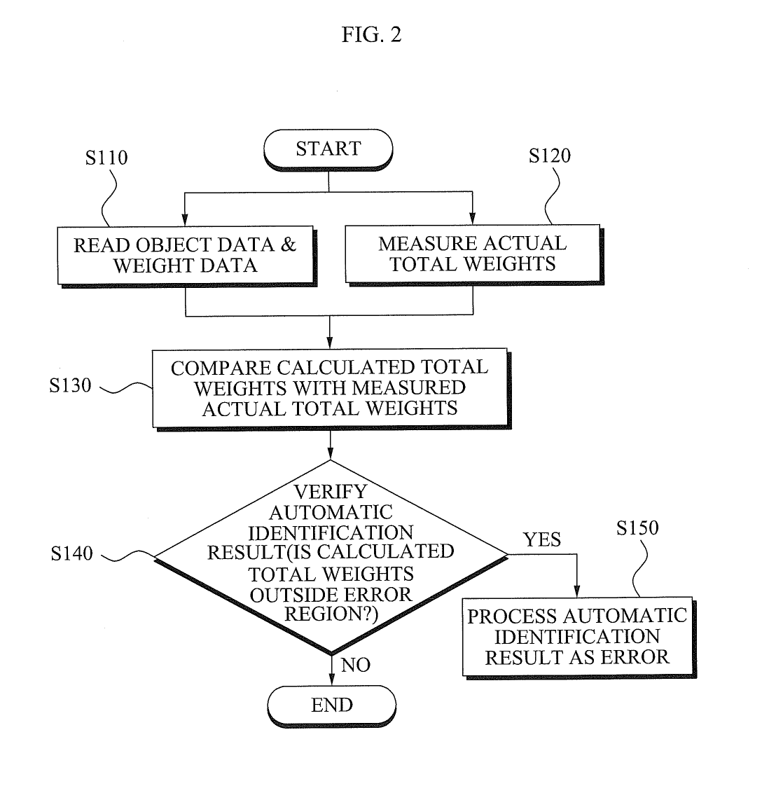

FIG. 1 illustrates an apparatus for verifying an identification of a radio frequency identification (RFID) tag according to an exemplary embodiment of the present invention, and FIG. 2 is a flowchart illustrating a method of verifying an identification of an RFID tag according to an exemplary embodiment of the present invention.

Referring to FIG. 1, the apparatus includes reading units 10 and 12, a measurement unit 20, a control unit 30, and a transfer unit 50. An object 1 corresponding to a measurement target is attached with an RFID tag 2 including weight data of the object 1, and a plurality of objects 1 constitutes a group to pass through a measurement region R. The reading units 10 and 12, the measurement unit 20, the control unit 30, and the transfer unit 50 are provided based on the measurement region R.

The reading units 10 and 12 may include a plurality of wireless readers and read necessary information using a radio frequency (RF) within the range of tens of KHz through GHz. In order to improve a reading ability, the reading units 10 and 12 may include the plurality of wireless readers in various types of angles and also may use readers with different characteristic.

The transfer unit 50 may locate the plurality of objects 1 in the measurement region R using a conveyer belt or other transfer units. Also, after completing the reading, the transfer unit 50 may classify the plurality of read objects based on a predetermined criterion and path. Depending on embodiments, a lift and the like may be used instead of the conveyer belt. Actual total weight and the like may be measured using the lift.

The measurement unit 20 capable of measuring the weight of the object 1 is provided in the measurement region R. According to the present exemplary embodiment, the measurement unit 20 is a weighing beam to measure the weight. However, according to another exemplary embodiment of the present invention, various types of measurement devices such as a volume measurement device, an infrared ray (IR) measurement device, and the like may be used depending on a characteristic of physical data to be measured.

Data read through the reading units 10 and 12, and the measurement unit 20 is transferred to the control unit 30. The control unit 30 may verify the identification of the RFID tag in a following manner. In the case of a normal process, it is possible to indicate a normal processing result using a normal process indication unit 42. Also, in the case of an error process, it is possible to indicate an error processing result using an error process indication unit 44. Also, it is possible to display a verification result about the identification of the RFID tag using a display such as a monitor, or other alerting units.

Hereinafter, the method of verifying the identification of the RFID tag will be described with reference to FIG. 2.

Referring to FIG. 2, the method includes operation S110 of reading object data and weight data from RFID tags attached to a plurality of objects; operation S120 of measuring actual total weight of the plurality of objects; operation S130 of comparing calculated total weight corresponding to a sum of the read data with the measured actual total weight; and operation S140 of verifying the automatic identification result about the plurality of objects based on the comparison between the calculated total weight and the measured actual total weight.

In operation S110 of reading object data and weight data from RFID tags attached to a plurality of objects, when the plurality of objects is located within the range where a reading unit can read the RFID tag, that is, when the plurality of objects is located in a measurement region, necessary data may be read from each of the RFID tags respectively attached to each of the plurality of objects. Here, the weight data included in the RFID tag may be uniformly recorded by a manufacturer. Also, a seller may directly measure the weight of the object and record the measured value in the RFID tag using a writable device.

The object data may indicate basic information of each object, for example, manufacturing location, a manufacturer, manufacturing date, and the like, that is recorded in the RFID tag as data. Also, the weight data may indicate the weight of each object that is recorded in the RFID tag as data. Generally, the RFID tag may be an RF tag attached to the object.

In operation S120 of measuring actual total weight of the plurality of objects, the actual total weight may be obtained by collectively measuring the weights of all of the plurality of objects and also may be obtained by consecutively measuring the weights of the plurality of objects for at least one object among the plurality of objects. As shown in FIG. 2, operations S110 and S120 may be simultaneously performed and also may be separately or sequentially performed.

In operation S130 of comparing calculated total weight corresponding to a sum of the read data with the measured actual total weight, the calculated total weight is a sum of the weight data of each object read from each RFID tag, and the measured actual total weight is the total weight that is obtained by collectively measuring the total weight of all of the plurality of objects, or summing up the consecutively measured weights of each object of the plurality of objects.

In operation S140 of verifying the automatic identification result about the plurality of objects, verifying whether the measured total weight is in a predetermined error range may be performed, as an example. In this case, when the measured total weight is within the error range, it is possible to process the automatic identification result as normal. Conversely, when the measured total weight is outside the error range, it is possible to process the automatic identification result as an error S150. Since it is unlikely that the measured value and the calculated value have the same exact value, it is possible to process the measured value and the calculated value as the same value when both the measured value and the calculated value are within the predetermined error range. Therefore, when the measured actual total weight is outside the error range, it is possible to determine that the object data is not identified from all the RFID tags of the plurality of objects.

The error range may be variously determined and be changed depending on an object type, a measurement unit, and the like. For example, in the case of the same object type, the error range may be determined as a relatively small value. Conversely, in the case of various object types, the error range may be determined as a relatively large value. Also, as the weight of the object is larger, the error range may be determined as a larger value.

In operation S150, although not illustrated, it is possible to re-read object data and weight data from RFID tags attached to the plurality of objects, and then compare recalculated total weight, which is a sum of the re-read object data, with the measured actual total weight, and repeat the re-reading until the recalculated total weight is within the error range.

Here, when the re-reading process is repeated more than a predetermined number of times, that the process is not normally processed is informed to a user so that the user may perform a subsequent procedure. The number of repeating times may be variously determined depending on an object type, an RF tag type, and the like.

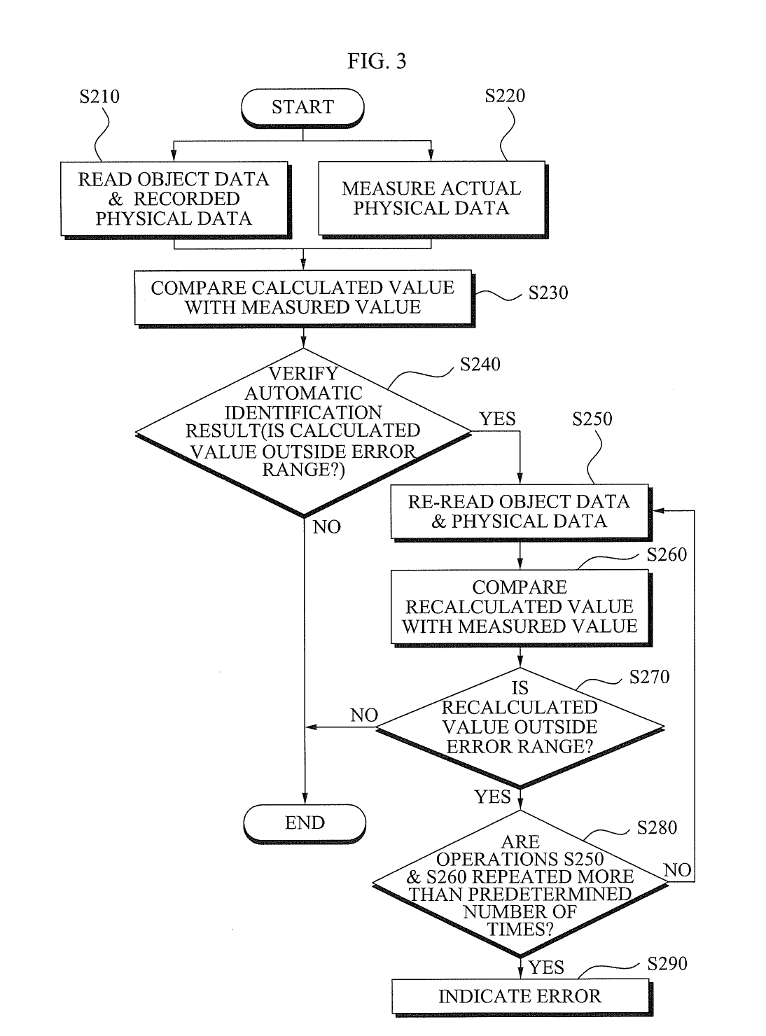

FIG. 3 is a flowchart illustrating a method of verifying an identification of an RFID tag according to another exemplary embodiment of the present invention.

As shown in FIG. 3, the method includes operation S210 of reading object data and the physical data from RFID tags attached to a plurality of objects; operation S220 of measuring actual physical data of the plurality of objects; operation S230 of comparing a measured value with a calculated value, wherein the calculated value is a sum of the read physical data and the measured value is a sum of the measured actual physical data; and operation S240 of verifying the automatic identification result about the plurality of objects based on the comparison between the calculated value and the measured value.

In operation S210 of reading object data and the physical data, when a plurality of objects is located within the range where an RFID tag reading unit can read an RFID tag, the data may be received from an RFID tag attached to each of the plurality of objects.

The object data denotes basic information of each object, for example, manufacturing location, a manufacturer, manufacturing date, and the like, that is recorded as data in the RFID tag. The recorded physical data denotes the physical characteristic of each data that is recorded as data in the RFID tag. The physical characteristic denotes a characteristic that determines a physical property of a material or a thermal, optical, electrical, or magnetic property as quantity. A representative example of the physical characteristic may be a weight, a volume, and the like. Also, the RFID tag may be an RF tag attached to the object.

In operation S220 of measuring actual physical data of the plurality of objects, the actual physical data may be obtained by collectively measuring the physical characteristic of all of the plurality of objects, and also may be obtained by consecutively measuring the physical characteristic of each object of the plurality of objects for at least one object among the plurality of objects.

In operation S230 of comparing a measured value with a calculated value, wherein the calculated value is a sum of the read physical data and the measured value is a sum of the measured actual physical data obtained in operation S220, when the physical data is, for example, data corresponding to the weight of the object, the calculated value is a sum of weight data read from each RFID tag and the measured value is the total weight that is obtained by collectively measuring the total weight of all of the plurality of objects, or summing up the consecutively measured weights of each object of the plurality of objects.

In operation S240 of verifying the automatic identification result about the plurality of objects, when the calculated value is outside the predetermined error range as the result of the comparison between the measured value and the calculated value, it is possible to process the automatic identification result as an error. Conversely, when the calculated value is within the predetermined error range as the result of the comparison between the measured value and the calculated value, it is possible to process the automatic identification result as normal.

Since it is unlikely that the measured value and the calculated value have the same exact value, it is possible to process the measured value and the calculated value as the same value when both the measured value and the calculated value are within the predetermined error range. Therefore, when a difference between the measured value and the calculated value is within the predetermined error range, it is regarded that the object data is identified from all the RFID tags attached to the plurality of objects and thus it is possible to process the automatic identification result as normal.

The error range may be variously determined and be changed depending on an object type, a measurement unit of the physical characteristic, and the like. For example, in the case of the same object type, the error range may be determined as a relatively small value. Conversely, in the case of various object types, the error range may be determined as a relatively large value. Also, when the physical data is, for example, data corresponding to the weight of the object, the error range may be determined as a larger value as the weight of the object increases.

As described above, when the calculated value is outside the error range as the result of the comparison between the measured value and the calculated value in operation S240 of verifying the automatic identification result about the plurality of objects, it is possible to process the automatic identification result as the error. In this case, operation S240 may be followed by operation S250 of re-reading the object data and the physical data from the RFID tags attached to the plurality of objects; and operation S260 of comparing the measured value with a recalculated value. The measured value is the sum of the measured actual physical data obtained in operation S220 and the recalculated value is a sum of the recorded physical data obtained in operation S250. When the recalculated value is outside the error range as the result of the comparison between the measured value and the recalculated value in operation S270, operations S250 and S260 may be repeated until the recalculated value is within the error range.

Here, when operations S250 and S260 are repeated more than a predetermined number of times as determined in operation S280, that the process is not normally processed is informed to a user, so that the user may perform a subsequent procedure. For example, it is possible to indicate the automatic identification result as the error process in operation S290. The number of repeating times may be variously determined depending on an object type, an RF tag type, and the like.

As described above, according to the present invention, there is provided a method and apparatus for verifying an identification of an RFID tag that can compare read physical data and measured actual physical data and thereby can more accurately verify whether an RFID tag reading unit has identified all the information from a plurality of RFID tags attached to a plurality of objects.

Also, according to the present invention, when a collision of an RFID tag occurs, or when a shield exists between an RFID tag and a reading unit and thus information is not completely read from a plurality of RFID tags, there is provided an error process indication unit to indicate an automatic identification result as an error process.

Also, according to the present invention, when information needs to be identified from a plurality of RFID tags attached to a plurality of objects respectively, such as in a physical distribution of a large scale, there is provided a unit to enable a reading unit to verify whether information is identified from all the RFID tags. Therefore, it is possible to readily check and correct an error that may occur during the information identification process, and thereby reduce a physical distribution processing time.

Also, according to the present invention, it is possible to further improve object information and object integrity by recording weight data or other physical data in an RFID tag. For example, since the weight data is recorded in the RFID tag and the actual weight is measured during an actual measurement process, a manufacturer may attempt to maintain a fixed quantity.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of verifying, using a radio frequency identification (RFID) tag, an automatic identification result about a plurality of objects, wherein each object is attached with an RFID tag including weight data of the object, the method comprising:
reading object data and the weight data from the RFID tag;
measuring actual total weight of the plurality of objects;
comparing the measured actual total weight with calculated total weight corresponding to a sum of the read weight data; and
verifying the automatic identification result about the plurality of objects through the comparison between the measured actual total weight and the calculated total weight.

2. The method of claim 1, wherein the verifying indicates the automatic identification result as an error process when the calculated total weight is outside a predetermined error range as the result of the comparison between the measured actual total weight and the calculated total weight.

3. The method of claim 1, wherein the verifying indicates the automatic identification result as a normal process when the calculated total weight is within a predetermined error range as the result of the comparison between the measured actual total weight and the calculated total weight.

4. A method of verifying, using an RFID tag, an automatic identification result about a plurality of objects, wherein each object is attached with the RFID tag including physical data corresponding to a physical characteristic of the object, the method comprising:
reading object data and the physical data from the RFID tag;
measuring actual physical data of each object of the plurality of objects;
comparing a measured value with a calculated value, wherein the calculated value is a sum of the read physical data and the measured value is a sum of the measured actual physical data; and
verifying the automatic identification result about the plurality of objects through the comparison between the calculated value and the measured value.

5. The method of claim 4, wherein the verifying indicates the automatic identification result as an error process when the calculated value is outside a predetermined error range as the result of the comparison between the measured value and the calculated value.

6. The method of claim 4, wherein the verifying indicates the automatic identification result as a normal process when the calculated value is within a predetermined error range as the result of the comparison between the measured value and the calculated value.

7. The method of claim 4, wherein the verifying comprises:
re-reading the object data and the physical data from the RFID tag when the calculated value is outside a predetermined error range as the result of the comparison between the measured value and the calculated value; and
comparing the measured value with a recalculated value, wherein the measured value is the sum of the measured actual physical data obtained in the measuring and the recalculated value is a sum of the physical data obtained in the re-reading,
wherein, when the recalculated value is outside the error range as the result of the comparison between the measured value and the recalculated value, the re-reading and the comparing is repeated until the recalculated value is within the error range.

8. The method of claim 7, further comprising:
indicating an error has occurred when the re-reading and the comparing is repeated at least a predetermined number of times.

9. The method of claim 4, wherein the measuring collectively measures the physical characteristic of all of the plurality of objects.

10. The method of claim 4, wherein the measuring consecutively measures the physical characteristic of the plurality of objects for at least one object among the plurality of objects.

11. The method of claim 4, wherein the reading and the measuring reads the object data and the physical data from the RFID tag of each of the plurality of objects and measures the actual physical data of each of the plurality of objects while passing through a predetermined measurement region.

12. The method of claim 4, wherein the physical characteristic of the object is a weight or a volume.

13. The method of claim 4, further comprising:
recording the physical data of the object in a corresponding RFID tag, prior to the reading.

14. An apparatus of verifying, using an RFID tag, an automatic identification result about a plurality of objects, wherein each object is attached with an RFID tag storing physical data corresponding to a physical characteristic of the object, the apparatus comprising:
a reading unit to read object data and the physical data from the RFID tag;
a measurement unit to measure actual physical data of the plurality of objects; and
a control unit to compare a measured value with a calculated value, wherein the calculated value is a sum of the read physical data and the measured value is a sum of the measured actual physical data.

15. The apparatus of claim 14, further comprising:
an error process indication unit to indicate the automatic identification result as an error process when the calculated value is outside a predetermined error range as the result of the comparison between the measured value and the calculated value.

16. The apparatus of claim 14, further comprising:
a normal process indication unit to indicate the automatic identification result as a normal process when the calculated value is within a predetermined error range as the result of the comparison between the measured value and the calculated value.

17. The apparatus of claim 14, wherein the measurement unit collectively measures the physical characteristic of all of the plurality of objects.

18. The apparatus of claim 14, wherein the measurement unit consecutively measures the physical characteristic of the plurality of objects for at least one object among the plurality of the objects.

19. The apparatus of claim 14, wherein the physical characteristic of the object is a weight or a volume.
